(19) United States
(12) Patent Application Publication
(10) Pub. No.: US 2021/0141979 A1
(43) Pub. Date: May 13, 2021

(54) METHODS FOR DESIGNING BUILDINGS, METHODS FOR SIZING BUILDING EQUIPMENT, AND CONSTRUCTING BUILDINGS SO DESIGNED

(71) Applicant: Covestro LLC, Pittsburgh, PA (US)

(72) Inventor: Gerald W. Phelan, McMurray, PA (US)

(21) Appl. No.: 16/682,176

(22) Filed: Nov. 13, 2019

(51) Int. Cl. G06F 30/23; E04B 1/76; F24F 11/30

(52) U.S. Cl. CPC G06F 30/23; G06F 2111/10; F24F 11/30; E04B 1/76

(57) ABSTRACT

Methods for designing buildings, method for constructing buildings, methods for sizing HVAC equipment for use in buildings, and methods for constructing or modifying buildings so designed. The methods involve performing a building energy simulation using a conduction finite difference algorithm using temperature dependent thermal conductivity data for thermal insulation at a plurality of mean temperatures within a temperature range of −50 to 200° F.

### FIELD

This specification relates to methods for designing buildings and methods for sizing equipment for use in buildings, as well as to the construction or modification of buildings so designed. The methods involve performing a whole-building energy simulation using a conduction finite difference (“CFD”) algorithm to calculate heat transfer across one or more opaque envelope surfaces.

### BACKGROUND

Insulation plays an important role in the energy efficiency and environmental impact of building envelopes. Various types of thermal insulation materials are available, including fiberglass, mineral wool, cellulose, and rigid foams, such as polystyrene and polyisocyanurate-modified polyurethane foam. Polyisocyanurate (sometimes referred to as “polyiso”) foam has many advantages, such as relatively low installed cost, good fire resistance and high thermal resistance. Regardless of the insulation material used, however, it is important to understand its thermal resistance performance.

North American manufacturers of building envelope thermal insulation test and report the R-value (a measure of thermal resistance used in the building and construction industry) of their products in compliance with industry standards, such as ASTM C-518. In order to allow for a simple, yet consistent procedure to measure and compare thermal performance, industry practice typically requires measurement of R-value at a specific mean temperature of, for example, 75° F. (23.9° C.). However, such a representation of R-value does not reflect performance of thermal insulation across the full range of insulation exposure temperatures and their frequencies.

Public awareness and interest in the benefits of increasing efficiency of buildings, along with the associated drive for increased stringency in energy codes, has ignited a trend in a comprehensive approach to performance-based design. This trend has contributed to a growth of engineering professionals dedicated to using state-of-the-art modeling tools to design buildings that deliver optimal and reliable energy performance. Their added challenge includes doing so while providing occupant thermal comfort and right sizing of heating, cooling and ventilation (“HVAC”) equipment in a very broad range of climates, all in a cost effective manner.

As a result, it would be desirable to provide a method for designing buildings and for sizing HVAC equipment for use in a building that accounts for the thermal insulation performance of an insulation material across the full range of insulation exposure temperatures and their frequencies, so that the most energy efficient and/or cost effective insulation material and HVAC equipment selections can be made, if desired.

The present invention was made in view of the foregoing.

### SUMMARY OF THE INVENTION

In some respects, this specification relates to methods for designing a building. These methods comprise: (a) performing a building energy simulation using a CFD algorithm using temperature dependent thermal conductivity data for thermal insulation at a plurality of mean temperatures within the temperature range of −50 to 200° F.; and (b) selecting a thermal insulation product for use on the building that provides a desired estimated annual energy consumption for the building at least partly based on the result of the building energy simulation.

In other respects, this specification relates to building construction. In particular, in some implementations, this specification is directed to methods for constructing an insulated building that comprises installing a thermal insulation product on the building. In these methods, the thermal insulation product is at least partly selected based on the result of a selection process comprising: (a) performing a building energy simulation using a CFD algorithm using temperature dependent thermal conductivity data for thermal insulation at a plurality of mean temperatures within the temperature range of −50 to 200° F.; and (b) selecting the thermal insulation product that provides a desired estimated annual energy consumption for the building based on the result of the building energy simulation.

In still other respects, this specification relates to methods for sizing equipment, such as HVAC equipment, for use in a building. These methods comprise: (a) identifying a thermal insulation product for use on the building; (b) performing a building energy simulation using a CFD algorithm using temperature dependent thermal conductivity data for the thermal insulation at a plurality of mean temperatures within the temperature range of −50 to 200° F.; and (c) sizing at least some of the equipment at least partly based on the result of the building energy simulation.

In yet other respects, this specification relates to methods for constructing or modifying an insulated building comprising thermal insulation and HVAC equipment. These methods comprise installing HVAC equipment in the building, wherein at least some of the HVAC equipment is sized based on the result of a building energy simulation conducted using a CFD algorithm using temperature dependent thermal conductivity data for the thermal insulation at a plurality of mean temperatures within the temperature range of −50 to 200° F.

### BRIEF DESCRIPTION OF THE DRAWINGS

Various features and characteristics of the inventions described in this specification may be better understood by reference to the accompanying figures, in which:

FIG. 1 illustrates the discretization method of a CFD algorithm;

FIG. 2 illustrates actual measured and presumed current practice temperature dependent R-value (“TDRV”) profiles of polyisocyanurate roof insulation materials evaluated in the Examples.

FIG. 3 is a depiction of a Department of Energy Prototype Strip Mall (having a building area of 2090.32 m²) used for the EnergyPlus simulation described in the Examples;

FIG. 4 illustrates the material input object for polyisocyanurate properties at 20° C. used in the Examples;

FIG. 5 illustrates the input object for the roof configuration description used in the Examples; and

FIG. 6 illustrates the input object for Material Property/Variable Thermal Conductivity properties for the CFD solution algorithm for Scenarios (2) and (3) of Example 1.

### DETAILED DESCRIPTION

Various embodiments are described and illustrated in this specification to provide an overall understanding of the structure, function, properties, and use of the disclosed inventions. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. § 112 and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, unless otherwise expressly indicated, all numerical parameters are to be understood as being prefaced and modified in all instances by the term “about”, in which the numerical parameters possess the inherent variability characteristic of the underlying measurement technique used to determine the numerical value of the parameter. At the very least, but without limiting the application of the doctrine of equivalents to the claims, each numerical parameter described in this specification should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As indicated, embodiments of this specification are directed to methods for designing a building. Such methods may be implemented by use of a computer program. These methods comprise performing a building energy simulation using a CFD algorithm. Through the utilization of temperature dependent thermal conductivity data for thermal insulation to be used on the building and with the simulation program extracting at least hourly frequency annual meteorological data from an appropriate TMY (Typical Meteorological Year) or similar file, the methods associate the actual conditions of such envelope surfaces with the specific temperature dependent thermal conductivity values to facilitate assessment of the thermal insulation performance on a whole building energy basis.

The energy simulation software, known as EnergyPlus (version 9.1.0), which is funded by the U.S. Department of Energy's Building Technologies Office, and managed by the National Renewable Energy Laboratory, can be used for this purpose. This CFD algorithm utilized is applied to the opaque portion(s) (as opposed to a portion of a wall or roof that is a window, for example) of a wall, floor, and/or roof surface (as selected by the user) by discretizing the opaque portion(s) of the wall, floor, and/or roof into several nodes (Δx being the distance between nodes) using a fully implicit scheme for a homogeneous material with uniform node spacing. This discretization is illustrated in FIG. 1. CFD uses the discretization method to establish Δx—the distance between nodes—which strives for a balance of precision and avoidance of computation overload.

The calculation method is derived from Fourier's Law and is according to the following equation:

CₚpΔx{Tᵢ^{j+1}−Tᵢ^{j})/Δt}=k_{W}{(Tᵢ₊₁^{j+1}−Tᵢ^{j+1})/Δx}+k_{E}{(Tᵢ₋₁^{j+1}−Tᵢ^{j+1})/Δx}

in which T is node temperature (in ° C., K); Δt is the calculation time step (hour); Δx is the finite difference layer thickness (meters); kw is the thermal conductivity for interface between i node and i+1 node (W/mK); k_{E} is the thermal conductivity for interface between i node and i−1 node (W/mK); i is the node being modeled; i+1 is the adjacent node to the interior of the construction; i−1 is the adjacent node to the exterior of the construction; j+1 is the new time step; j is the previous time step; Cₚ is specific heat (J/kg·K); and p is density (kg/m³) of the material representing the specific layer of the opaque portion(s) of the wall, floor, and/or roof surface.

The CFD algorithm is iterative in that it continues to use improved guesses for both surface temperatures until it converges to a value within a tolerance range. EnergyPlus requires initial input allowing the program to determine a thermal conductivity associated with any value of node temperature. These inputs are (i) thermal conductivities (k) and temperatures, (ii) the thermal conductivity (k) value for a theoretical material thermal conductivity which is assumed to be constant regardless of temperature, (iii) building type, such as a Department of Energy Prototype Strip Mall, and selected locations with available representative meteorological files where 65° F. (18.3° C.) Basis Heating Degree Days (HDD65; HDD18) values are greater than 2000, such as at least 3, at least 4, at least 5, or, in some cases, at least 6 or at least 7 locations within Climate Zones 4-7, such as, for example, Baltimore, Md., Chicago, Ill., Vancouver, British Columbia, Toronto, Ontario, Burlington, Vt., Calgary, Alberta, and Duluth, Minn.

The EnergyPlus CFD algorithm is also described in Verification and Validation of EnergyPlus Conduction Finite Difference and Phase Change Material Models for Opaque Wall Assemblies, Tabares-Velasco et al., National Renewable Energy Laboratory Technical Report NREL/TP-5500-55792 (July 2012), which is incorporated herein by reference.

In the methods of this specification, the building energy simulation using a CFD algorithm is performed using temperature dependent thermal conductivity data for thermal insulation at a plurality of mean temperatures within the temperature range of −50° F. to 200° F., such as −20° F. to 150° F.

Thermal conductivity data from any of a variety of different types of thermal insulation can be used for such a simulation, including, for example, fiberglass, mineral wool, cellulose, and foam insulation, i.e., a cellular plastic insulation that contains cells enclosed with a gas, such as air or another gas, such as is the case with, for example, extruded polystyrene and polyisocyanurate-modified polyurethane foams.

In some implementations, thermal conductivity data from a polyisocyanurate-modified polyurethane foam may be employed, such a foam being produced from a polyisocyanurate foam-forming composition comprising a blowing agent composition comprising, for example, one or more hydrocarbon blowing agents with an atmospheric pressure boiling point of at least 68° F. (20° C.), though other physical blowing agent, such as fluoroolefins and fluorocarbons, can be readily envisioned.

More particularly, such polyisocyanurate foam-forming compositions, in some implementations, comprise: (a) an organic polyisocyanate; (b) a polymeric polyol with a nominal functionality of at least 2.0, and (c) a blowing agent composition comprising one or more hydrocarbon blowing agents with an atmospheric pressure boiling point of at least 68° F. (20° C.).

Any of the known organic polyisocyanates can be used. Examples of suitable polyisocyanates include, without limitation, substituted or unsubstituted aromatic, aliphatic, and cycloaliphatic polyisocyanates having at least two isocyanate groups. Polyfunctional aromatic isocyanates are often used. Specific examples of suitable aromatic isocyanates include, but are not limited to, 4,4′-diphenylmethane diisocyanate (MDI), polymeric MDI (pMDI), toluene diisocyanate, allophanate-modified isocyanates, isocyanate-terminated prepolymers and carbodiimide-modified isocyanates. In some embodiments, the organic polyisocyanate comprises pMDI having an average NCO functionality of from 2.2 to 3.3 and a viscosity of from 25 to 2000 mPas and prepolymers thereof prepared with polyols or other oligomers or polymers such as polyether or polyester polyols that contain active hydrogen atoms. In certain embodiments, the pMDI has a functionality of from 2.2 to 3.0 and a viscosity less than about 800 mPas at 25° C. Any mixtures of organic polyisocyanates may, of course, be used.

In some implementations, the organic polyisocyanate(s) is/are included in the foam-forming system, i.e., composition, in an amount of at least 50%, such as from 55% to 75%, or, in some cases, from 59% to 69% by weight, based on total weight of the foam-forming composition.

Any material having at least two reactive groups capable of reacting with an isocyanate group is suitable for use in the polyisocyanurate foam-forming composition. In certain embodiments, the isocyanate-reactive material comprises a polyester polyol (such as an aromatic polyester polyol) and/or a polyether polyol, such as those having an average hydroxyl functionality of from 2 to 8, such as 2 to 6, or, in some cases, 2.0 to 2.5, and/or a hydroxyl number of 100 mg KOH/gm to 1000 mgKOH/gm or, in some cases, 200 mgKOH/gm to 500 mgKOH/gm. In certain embodiments, a blend of an aromatic polyester polyol and a polyester and/or polyether polyol that contains renewable content derived from incorporation of regenerable materials, such as fatty acid triglycerides, sugar, or natural glycerin, is used.

In certain embodiments, the polyol(s) is/are a present in an amount of 10% to 40%, such as 20% to 40%, or, in some cases, 25% to 35% by weight, based on total weight of the foam-forming composition.

The relative amounts of organic polyisocyanate and polymeric polyol(s) used in the polyisocyanurate foam-forming composition is often selected to provide the composition with a NCO:OH index of at least 1.8, such as at least 2.0, or, in some cases, 2.0 to 3.0.

As indicated, the polyisocyanurate foam-forming composition comprises a blowing agent composition comprising, in some implementations, one or more hydrocarbon blowing agents with an atmospheric pressure boiling point of at least 20° C. (68° F.). In certain embodiments, the blowing agent composition comprises a hydrocarbon with an atmospheric pressure boiling point of at least 20° C. (68° F.) and water. As used herein, “hydrocarbon” refers to chemical compounds composed primarily of carbon and hydrogen that may contain heteroatoms such as oxygen, nitrogen, sulfur, or other elements.

Specific examples of hydrocarbons with an atmospheric pressure boiling point of at least 20° C. (68° F.) include, but are not limited to, n-pentane (atmospheric pressure boiling point of 36.1° C. (96.9° F.)), isopentane (atmospheric pressure boiling point of 27.7° C. (81.9° F.)), cyclopentane (atmospheric pressure boiling point of 49° C. (120.2° F.)), hexane (atmospheric pressure boiling point of 68° C. (154.4° F.)), 2,2-dimethylbutane (atmospheric pressure boiling point of 50° C. (122° F.)), 2-methylpentane (atmospheric pressure boiling point of 60° C. (140° F.)), 1-hexene (atmospheric pressure boiling point of 63° C. (145.4° F.)), 1-pentene (atmospheric pressure boiling point of 30° C. (86° F.)), acetone (atmospheric pressure boiling point of 56° C. (132.8° F.)), acetaldehyde (atmospheric pressure boiling point of 20.2° C. (68.4° F.)), dimethyl carbonate (atmospheric pressure boiling point of 90° C. (194° F.)), methylal (atmospheric pressure boiling point of 42.3° C. (108.1° F.)), ethyl formate (atmospheric pressure boiling point of 54.3° C. (129.7° F.)), methyl acetate (atmospheric pressure boiling point of 56.9° C. (134.4° F.)), and methyl formate (atmospheric pressure boiling point of 31.8° C. (89.2° F.)). As will of course be appreciated, mixtures of two or more of any of the foregoing or unlisted suitable hydrocarbons can be used. In certain embodiments, the hydrocarbons with an atmospheric pressure boiling point of at least 20° C. (68° F.) is n-pentane, isopentane, cyclopentane, methyl formate, and/or methylal.

In certain embodiments, the hydrocarbon with an atmospheric pressure boiling point of at least 20° C. (68° F.) is present in an amount of at least 1% by weight, such as at least 2% by weight, or, in some cases, at least 3% by weight and up to 10% by weight, such as up to 8% by weight, or, in some cases, up to 6% by weight, based on total weight of the foam-forming composition.

In addition to the hydrocarbon blowing agent, some water is often included in the blowing agent composition. Water reacts with isocyanates to produce carbon dioxide gas as an auxiliary blowing agent. The amount of water included in the foam-forming composition will often range from 0.05% to 1.0% by weight, such as 0.1% to 0.8% by weight, based on total weight of the foam-forming composition.

It is also possible that the blowing agent composition comprises a hydrocarbon, such as a hydrofluoroolefin, having an atmospheric pressure boiling point of less than 20° C. (68° F.), specific examples of which include, but are not limited to, butane (atmospheric pressure boiling point of −1° C. (30.2° F.)), isobutane (atmospheric pressure boiling point of −11.7° C. (10.9° F.)), butylene (atmospheric pressure boiling point of −6.6° C. (20.1° F.)), isobutylene (atmospheric pressure boiling point of −6.9° C. (19.6° F.)), trans-1-chloro-3,3,3-trifluoropropene (atmospheric pressure boiling point of 19° C. (66.2° F.)), and dimethyl ether (atmospheric pressure boiling point of −24° C. (−11.2° F.)).

In addition, the polyisocyanurate foam-forming composition may include any of a variety of optional ingredients.

The polyisocyanurate foam-forming composition also often includes a flame retardant composition. Suitable flame retardants for use in the foam-forming composition include, without limitation, halogenated, such as brominated flame retardants, such as brominated polyols, and phosphonated flame retardants, such as a halogenated, such as chlorinated, phosphates.

The polyisocyanurate foam-forming composition often also comprises a surfactant to, for example, stabilize the foaming reaction mixture until it obtains rigidity. Such surfactants often comprise a liquid or solid organo silicon compound, a polyethylene glycol ether of a long chain alcohol, a tertiary amine, an alkanolamine salt of a long chain alkyl acid sulfate ester, an alkylsulfonic ester, or an alkylarylsulfonic acid, or a mixture thereof. Such surfactants are employed in amounts sufficient to stabilize the foaming reaction mixture against collapse and the formation of large and uneven cells.

In certain embodiments, one or more catalysts are used in the foam-forming composition. Any suitable catalyst may be used including tertiary amines, such as, without limitation, triethylenediamine, N-methylmorpholine, pentamethyl diethylenetriamine, dimethylcyclohexylamine, tetra-methylethylenediamine, 1-methyl-4-dimethylaminoethyl-piperazine, 3-methoxy-N-dimethyl-propylamine, N-ethylmorpholine, diethylethanol-amine, N-cocomorpholine, N,N-dimethyl-N′,N′-dimethylisopropyl-propylene diamine, N,N-diethyl-3-diethyl aminopropylamine and dimethyl-benzyl amine. A catalyst for the trimerization of polyisocyanates, such as an alkali metal alkoxide or carboxylate, or certain tertiary amines, are often employed.

The polyisocyanurate-modified polyurethane foam is produced by reacting the organic polyisocyanate and the isocyanate-reactive composition in the presence of the blowing agent composition. The resulting foam is typically “rigid” foam, which for purposes of the present invention refers to a foam that meets the compressive strength and flexural strength values listed in Table 1 of ASTM C1289-15.

As will be appreciated, heat transfer across a building envelope assembly occurs upon exposure to a temperature gradient between its interior surfaces and the outside environment. The mechanisms of heat transfer are convection, radiation and conduction. The purpose of insulation is to limit heat transfer via convection and radiation while reducing the rate (or heat flux) of conductive transfer. Heat transfer by conduction is described by Fourier's Law and Equation.

Conduction heat flux is determined from knowledge of the temperature distribution in a medium or Q=−k*dT/dx, in which the minus sign accounts for heat moving in the direction of decreasing temperature, k represents the thermal conductivity property of the material, and dT/dx the temperature differential across its thickness.

A thorough explanation of heat transfer across an insulated assembly requires consideration of other aspects including: (1) the heat capacitance of the materials comprising the assembly; (2) any phase change occurrences that may take place for the insulation across the range of exposure temperatures in the specific assembly and for the specific location; and (3) the function of insulation steady-state thermal conductivity versus temperature across the range of exposure temperatures in the specific assembly and for the specific location.

Heat capacitance, often referred to as “thermal mass”, depends on the heat capacity property of the material multiplied by the mass of the material or, as described by the last term in the First Law of Thermodynamics for a roof assembly:

$$0 = \{ \begin{matrix}Rate of Heat \\ Transfer Entering \\ Roof Insulation \\ Surface \end{matrix} \} - \{ \begin{matrix}Rate of Heat \\ Transfer Exiting \\ Roof Insulation \\ Surface \end{matrix} \} - \{ \begin{matrix}Rate of Accumulation \\ of Energy Within \\ Roof Insulation \\ Surface \end{matrix} \}$$

Generally speaking, insulation materials contain gas within its confines. Therefore, they exhibit variability of thermal conductivity with temperature, i.e., kinetic effects increase as temperature increases. In addition, polyisocyanurate insulation in particular often contains a blowing agent, such as the hydrocarbons described earlier, which experiences the onset of condensation at a point below room temperature, i.e., 75° F., but within the exposure temperature range associated with a building's heating season. Therefore, at that point and below, the thermal conductivity of such insulation increases as temperature decreases.

An aspect of the methods of this specification involves deriving an insulation's thermal resistance vs. temperature profile for the full insulation exposure mean temperature range for the location of the building under analysis. ASTM C1058/C1058M-10, “Standard Practice for Selecting Temperatures for Evaluating and Reporting Thermal Properties of Thermal Insulation”, can be used for determining the exposure mean temperature range. In some implementations, therefore, the thermal properties of insulation is evaluated at least over a mean temperature range that represents the intended end use, in which the lowest and greatest mean temperatures are within 10° C. of the maximum and minimum mean temperature of interest.

Some insulation materials, such as fiberglass, mineral wool, and cellulose, typically enclose air as the insulating gas. For these materials, the R-value/Mean Temperature relationship is linear throughout the exposure range. As such, three measurements taken across a relatively broad temperature range would suffice as an appropriate representation of its profile. On the other hand, profiles of cellular insulations enclosing a gaseous substance(s) with a boiling point(s) within the exposure range are not necessarily represented by a linear relationship. Therefore, in accordance with ASTM C1058/C1058M-10, several measurements across the exposure range must be taken for polyisocyanurate insulation of the type described earlier, in which a hydrocarbon is employed as the blowing agent, with small increments near an inflection point (described below), in order to establish its representative profile.

Thus, according some implementations of the methods of this specification, the thermal resistance of an insulation material, such as a polyisocyanurate-modified polyurethane foam is measured in accordance, for example, with CAN/UL S770-09 (in the case of a permeable faced polyisocyanurate-modified polyurethane foam) at a plurality of temperatures. These measurements may, for example, be used identify a calculated inflection point temperature below which defines a first mathematical correlation between temperature and the thermal resistance of the insulation material and above which defines a second mathematical correlation between temperature and the thermal resistance of the insulation material. In certain embodiments, the thermal resistance is measured in accordance with CAN/UL S770-09 at (i) a plurality of temperatures, such as at least 3, at least 4, at least 5, at least 6, at least 7, or, in some cases, at least 8 temperatures less than 75° F. (23.9° C.), such as a plurality of temperatures within the range of 20° F. to less than 75° F. (−6.7° C. to less than 23.9° C.), and (ii) a plurality of temperatures at 75° F. (23.9° C.) and higher, such as at least 3 or at least 4 temperatures at and above 75° F. (23.9° C.), such as a plurality of temperatures within the range of 75° F. to 105° F. (23.9° C. to 40.6° C.). In the present invention, the plurality of insulation mean temperatures and the temperature differences between the parallel plates should be chosen such that the practices described in ASTM C1058 (2010), Standard Practice for Selecting Temperatures for Evaluating and Reporting Thermal Properties of Thermal Insulation, Section 4 and ASTM C1045 (2007), Standard Practice for Calculating Thermal Transmission Properties under Steady State Conditions, Section 6.2 are followed.

In some cases, it may be necessary to acquire thermal conductivity data for an insulation material at temperatures below 20° F., such as temperature from −50 to 20° F. Various ways of acquiring such data can be readily envisioned. For example, one may use a heat flow meter that utilizes a coolant that is not water and that is capable of use at such low temperatures. Alternatively, one may extrapolate such values based on physical science phenomena considering the entrapped gas in the insulation material, as would be understood by those skilled in the art.

More particularly, as described herein, the calculated inflection point temperature is the temperature at which a line having a negative slope as defined by a linear regression fit of the thermal resistance measurements within the temperature range where thermal resistance increases with decreasing temperature (hereinafter a “warm side line”) intersects with a line having a positive slope as defined by a linear regression fit of the thermal resistance measurements within the temperature range where thermal resistance decreases with decreasing temperature (hereinafter a “cold side line”). These linear regressions fits define the mathematical correlations between temperature and thermal resistance for the insulation material being evaluated.

Based on the foregoing measurements, the variable thermal conductivities are inputs into the EnergyPlus CFD algorithm, which allows for up to 10 pairs of thermal conductivity/temperature entries. These inputs may reflect the foregoing linear regression fit of the measurement data, for example.

Based on the various inputs mentioned earlier, i.e., (i) thermal conductivities (k) and temperatures, (ii) the thermal conductivity (k) value for a theoretical material thermal conductivity which is assumed to be constant regardless of temperature, and (iii) building type and meteorological file representative of the selected location, EnergyPlus uses a linear solution to execute whole building simulations to determine a thermal conductivity associated with any temperature between two sequential input value pairs and to predict an annual building heating energy and cooling energy consumption for each inputted location. The output of EnergyPlus is a prediction of the annual heating energy and cooling energy consumption for the selected building type at each selected location.

According to some implementations of the methods of this specification, the foregoing building simulation can be conducted using a plurality of, such as 2, 3, 4 or more, different thermal insulation materials. Thereafter, a thermal insulation product can be selected for use on a building that provides a desired estimated annual energy consumption for the building at least partly based on the result of the building energy simulations.

For example, in some implementations, a plurality of polyisocyanurate-modified polyurethane foams may be evaluated according to CAN/UL S770-09 at a plurality of temperatures to identify a calculated inflection point temperature below which defines a first mathematical correlation between temperature and the thermal resistance of the insulation material and above which defines a second mathematical correlation between temperature and the thermal resistance of the insulation material. The resulting thermal conductivity as a function of temperature (k[T]) profile (“TDRV Profile”) for the various foams can be plotted, an example of such a plot is illustrated by FIG. 2, in which the horizontal lines represent a single thermal conductivity assumed value for an insulation material regardless of the temperature.

Using the TDRV Profiles, a CFD algorithm using the variable thermal conductivity input reflective of the TDRV Profile for each insulation material, as well as a selected building type, location, roof configuration, a design optimization analysis can be completed. For example, a net present value life cycle cost representation of results can be selected. In one implementation, the design optimization may comprise simulating a building's annual conditioning energy consumption, i.e., energy consumption for heating, cooling, and fans, for each of a plurality of different insulation materials. The building can then be designed at least partially on the basis of the result of such a simulation, such as by selecting an insulation material that results in, based on the insulation materials evaluated, the lowest annual conditioning energy consumption, the lowest net present value life cycle cost, which accounts for both the installed first cost of the insulation and the building life cycle energy consumption costs, or the insulation material with the highest heat loss weighted R-value.

The methods of this specification, therefore, facilitate establishing a holistic economic perspective for accessing roof insulation performance and comparison of available technologies for a specific building design by utilizing a particular insulation material's TDRV Profile to simulate building energy consumption.

In other aspects, the methods described herein can be used in the sizing of at least some of the HVAC equipment, such as furnaces, air conditioning units, and fans, to be used in the building at least partly based on the result of the building energy simulation. The “right” sizing of HVAC equipment is paramount to the cost, energy efficiency and occupant comfort of any building design. In order to insure year round occupant comfort, sizing design calculations utilize extreme conditions for the given building and its location—extreme cold outdoor temperature for heating equipment design and extreme hot outdoor temperature (and humidity) for cooling equipment. In light of this, conventional acceptance of an insulation R-value at 75° F. to represent all surface temperature exposures along with use of the CTF algorithm can be particularly problematic. By utilizing the methods described in this specification to obtain more accurate annual energy consumption estimations for a particular building in a particular location utilizing a selected insulation material, a building designer can more accurately size HVAC equipment, while ensuring occupant comfort, thereby providing making more cost effective design decisions. As such, in addition to insulation first costs and energy consumption cost savings/penalties, HVAC equipment cost savings/penalties can be included in the analyses.

As will be appreciated, such equipment sizing may be accomplished using a sizing calculation that is part of the building energy simulation program itself or it may be conducted using a separate acceptable sizing calculation procedure/software program.

As should be appreciated, aspects of this specification also relate to building construction or modification. In particular, in some implementations, this specification is directed to methods for constructing or modifying an insulated building that comprises installing a thermal insulation product on the building. In these methods, the thermal insulation product is at least partly selected based on the result of a selection process comprising performing a building energy simulation of the type described in this specification. In some implementations, this specification relates to methods for constructing or modifying an insulated building comprising thermal insulation and HVAC equipment that comprise installing HVAC equipment in the building, wherein at least some of the HVAC equipment that is sized based on the result of a building energy simulation of the type described in this specification.

Various aspects of the subject matter described in this specification are set out in the following numbered clauses:

Clause 1. A method, such as a computer-implemented method, for designing a building, comprising: (a) performing a building energy simulation using a CFD algorithm using temperature dependent thermal conductivity data for thermal insulation at a plurality of mean temperatures within the temperature range of −50 to 200° F.; and (b) selecting a thermal insulation product for use on the building that provides a desired estimated annual energy consumption for the building at least partly based on the result of the building energy simulation.

Clause 2. The method of clause 1, wherein the thermal insulation product comprises foam insulation, such as an extruded polystyrene or polyisocyanurate-modified polyurethane foam.

Clause 3. The method of clause 2, wherein the polyisocyanurate-modified polyurethane foam is the product of a polyisocyanurate foam-forming composition comprising a blowing agent composition comprising one or more hydrocarbon blowing agents with an atmospheric pressure boiling point of at least 68° F. (20° C.), such as where the hydrocarbon blowing agent with an atmospheric pressure boiling point of at least 68° F. (20° C.) comprises n-pentane, isopentane, cyclopentane, or a mixture of any two or more thereof.

Clause 4. The method of one of clause 1 to clause 3, wherein the temperature dependent thermal conductivity data is generated by measuring the thermal resistance of the thermal insulation in accordance with, for example, CAN/UL S770-09, at a plurality of temperatures to identify a calculated inflection point temperature below which defines a first mathematical correlation between temperature and the thermal resistance of the insulation material and above which defines a second mathematical correlation between temperature and the thermal resistance of the insulation material.

Clause 5. The method of clause 4, wherein the plurality of temperatures comprises at least 3, at least 4, at least 5, at least 6, at least 7, or at least 8 temperatures less than 75° F. (23.9° C.), such as temperatures within the range of 20° F. to less than 75° F. (−6.7° C. to less than 23.9° C.), and at least 3 or at least 4 temperatures at and above 75° F. (23.9° C.), such as temperatures within the range of 75° F. to 105° F. (23.9° C. to 40.6° C.).

Clause 6. The method of one of clause 1 to clause 5, wherein the step of performing a building energy simulation using a CFD algorithm using temperature dependent thermal conductivity data for thermal insulation at a plurality of mean temperatures within the temperature range of −50 to 200° F. comprises conducting the simulation using a plurality of different thermal insulations having different mathematical correlations and different calculated inflection point temperatures, such as where the plurality of different thermal insulation comprises a plurality of polyisocyanurate-modified polyurethane foams.

Clause 7. The method of one of clause 1 to clause 6, comprising selecting a net present value life cycle cost representation of results.

Clause 8. The method of one of clause 1 to clause 7, comprising simulating a building's annual conditioning energy consumption for each of a plurality of different insulation materials.

Clause 9. The method of one of clause 1 to clause 8, comprising designing the building with the insulation material that results in, based on the insulation materials evaluated, the lowest annual conditioning energy consumption, the lowest net present value life cycle cost, or the highest heat loss weighted R-value.

Clause 10. A method for constructing an insulated building, comprising installing a thermal insulation product on the building, wherein the thermal insulation product is at least partly selected based on the method of one of clause 1 to clause 9.

Clause 11. A method for constructing an insulated building, comprising installing a thermal insulation product on the building, wherein the thermal insulation product is at least partly selected by a method comprising: (a) performing a building energy simulation using a CFD algorithm using temperature dependent thermal conductivity data for thermal insulation at a plurality of mean temperatures within the temperature range of −50 to 200° F.; and (b) selecting a thermal insulation product for use on the building that provides a desired estimated annual energy consumption for the building at least partly based on the result of the building energy simulation.

Clause 12. The method of clause 11, wherein the thermal insulation product comprises foam insulation, such as an extruded polystyrene or polyisocyanurate-modified polyurethane foam.

Clause 13. The method of clause 12, wherein the polyisocyanurate-modified polyurethane foam is the product of a polyisocyanurate foam-forming composition comprising a blowing agent composition comprising one or more hydrocarbon blowing agents with an atmospheric pressure boiling point of at least 68° F. (20° C.), such as where the hydrocarbon blowing agent with an atmospheric pressure boiling point of at least 68° F. (20° C.) comprises n-pentane, isopentane, cyclopentane, or a mixture of any two or more thereof.

Clause 14. The method of one of clause 11 to clause 13, wherein the temperature dependent thermal conductivity data is generated by measuring the thermal resistance of the thermal insulation at a plurality of temperatures in accordance with, for example, CAN/UL S770-09, to identify a calculated inflection point temperature below which defines a first mathematical correlation between temperature and the thermal resistance of the insulation material and above which defines a second mathematical correlation between temperature and the thermal resistance of the insulation material.

Clause 15. The method of clause 14, wherein the plurality of temperatures comprises at least 3, at least 4, at least 5, at least 6, at least 7, or at least 8 temperatures less than 75° F. (23.9° C.), such as temperatures within the range of 20° F. to less than 75° F. (−6.7° C. to less than 23.9° C.), and at least 3 or at least 4 temperatures at and above 75° F. (23.9° C.), such as temperatures within the range of 75° F. to 105° F. (23.9° C. to 40.6° C.).

Clause 16. The method of one of clause 11 to clause 15, wherein the step of performing a building energy simulation using a CFD algorithm using temperature dependent thermal conductivity data for thermal insulation at a plurality of mean temperatures within the temperature range of −50 to 200° F. comprises conducting the simulation using a plurality of different thermal insulations having different mathematical correlations and different calculated inflection point temperatures, such as where the plurality of different thermal insulation comprises a plurality of polyisocyanurate-modified polyurethane foams.

Clause 17. The method of one of clause 11 to clause 16, wherein the method of selecting the thermal insulation product further comprises selecting a net present value life cycle cost representation of results.

Clause 18. The method of one of clause 11 to clause 17, wherein the method of selecting the thermal insulation product further comprises simulating a building's annual conditioning energy consumption for each of a plurality of different insulation materials.

Clause 19. The method of one of clause 11 to clause 18, wherein the method of selecting the thermal insulation product comprises designing the building with the insulation material that results in, based on the insulation materials evaluated, the lowest annual conditioning energy consumption, the lowest net present value life cycle cost, or the highest heat loss weighted R-value.

Clause 20. A method, such as a computer-implemented method, for sizing HVAC equipment for use in a building, comprising: (a) identifying a thermal insulation product for use on the building; (b) performing a building energy simulation using a CFD algorithm using temperature dependent thermal conductivity data for the thermal insulation at a plurality of mean temperatures within the temperature range of −50 to 200° F.; and (c) sizing at least some of the HVAC equipment at least partly based on the result of the building energy simulation.

Clause 21. The method of clause 21, wherein the thermal insulation product comprises foam insulation, such as an extruded polystyrene or polyisocyanurate-modified polyurethane foam.

Clause 22. The method of clause 22, wherein the polyisocyanurate-modified polyurethane foam is the product of a polyisocyanurate foam-forming composition comprising a blowing agent composition comprising one or more hydrocarbon blowing agents with an atmospheric pressure boiling point of at least 68° F. (20° C.), such as where the hydrocarbon blowing agent with an atmospheric pressure boiling point of at least 68° F. (20° C.) comprises n-pentane, isopentane, cyclopentane, or a mixture of any two or more thereof.

Clause 23. The method of one of clause 20 to clause 22, wherein the temperature dependent thermal conductivity data is generated by measuring the thermal resistance of the thermal insulation in accordance with, for example, CAN/UL S770-09, at a plurality of temperatures to identify a calculated inflection point temperature below which defines a first mathematical correlation between temperature and the thermal resistance of the insulation material and above which defines a second mathematical correlation between temperature and the thermal resistance of the insulation material.

Clause 24. The method of clause 23, wherein the plurality of temperatures comprises at least 3, at least 4, at least 5, at least 6, at least 7, or at least 8 temperatures less than 75° F. (23.9° C.), such as temperatures within the range of 20° F. to less than 75° F. (−6.7° C. to less than 23.9° C.), and at least 3 or at least 4 temperatures at and above 75° F. (23.9° C.), such as temperatures within the range of 75° F. to 105° F. (23.9° C. to 40.6° C.).

Clause 25. The method of one of clause 20 to clause 24, comprising selecting a net present value life cycle cost representation of results.

Clause 26. The method of one of clause 20 to clause 25, comprising simulating a building's annual conditioning energy consumption for each of a plurality of different HVAC equipment.

Clause 27. A method comprising installing HVAC equipment in a building, wherein at least some of the HVAC equipment is sized by the method of one of clause 20 to clause 26.

Clause 28. A method for constructing or modifying an insulated building comprising thermal insulation and HVAC equipment, comprising installing HVAC equipment in the building, wherein at least some of the HVAC equipment is sized based on the result of a building energy simulation conducted using a CFD algorithm using temperature dependent thermal conductivity data for the thermal insulation at a plurality of mean temperatures within the temperature range of −50 to 200° F.

Clause 29. The method of clause 28, wherein the thermal insulation comprises foam insulation, such as an extruded polystyrene or polyisocyanurate-modified polyurethane foam.

Clause 30. The method of clause 29, wherein the polyisocyanurate-modified polyurethane foam is the product of a polyisocyanurate foam-forming composition comprising a blowing agent composition comprising one or more hydrocarbon blowing agents with an atmospheric pressure boiling point of at least 68° F. (20° C.), such as where the hydrocarbon blowing agent with an atmospheric pressure boiling point of at least 68° F. (20° C.) comprises n-pentane, isopentane, cyclopentane, or a mixture of any two or more thereof.

Clause 31. The method of one of clause 28 to clause 30, wherein the temperature dependent thermal conductivity data is generated by measuring the thermal resistance of the thermal insulation in accordance with, for example, CAN/UL S770-09, at a plurality of temperatures to identify a calculated inflection point temperature below which defines a first mathematical correlation between temperature and the thermal resistance of the insulation and above which defines a second mathematical correlation between temperature and the thermal resistance of the insulation.

Clause 32. The method of clause 31, wherein the plurality of temperatures comprises at least 3, at least 4, at least 5, at least 6, at least 7, or at least 8 temperatures less than 75° F. (23.9° C.), such as temperatures within the range of 20° F. to less than 75° F. (−6.7° C. to less than 23.9° C.), and at least 3 or at least 4 temperatures at and above 75° F. (23.9° C.), such as temperatures within the range of 75° F. to 105° F. (23.9° C. to 40.6° C.).

Clause 33. The method of one of clause 28 to clause 32, comprising selecting a net present value life cycle cost representation of results of the building energy simulation.

Clause 34. The method of one of clause 28 to clause 33, wherein the sizing comprises simulating a building's annual conditioning energy consumption for each of a plurality of different HVAC equipment.

The non-limiting and non-exhaustive examples that follow are intended to further describe various non-limiting and non-exhaustive embodiments without restricting the scope of the embodiments described in this specification.

### EXAMPLES

### Example 1

In this Example, the Strip Mall model, illustrated by FIG. 3, and one of 17 prototype commercial buildings sponsored by the U.S. Department of Energy (“DOE”) and developed by the Pacific Northwest National Laboratory (“PNNL”), was used with populated EnergyPlus input files. The EnergyPlus input file reflects an ASHRAE 90.1-2016 compliant model. The selected location was Rochester, Minn. which is in ASHRAE Climate Zone 6A. Current energy code requirements include a minimum of R-30° F.·ft²·hr/Btu of insulation for this roof configuration (designated as Insulation Entirely Above Deck, LEAD) for Climate Zone 6A. Two layers of 2.6 inch thick of polyisocyanurate insulation were inputted for each scenario.

The thermal conductivity of various polyisocyanurate roof insulation materials was measured at several mean temperatures according to the method described in CAN/UL S770-09. From these measurements, TDRV Profiles were generated, which are illustrated by FIG. 2. As current standard requirements cited by building codes mandate insulation manufacturers to measure and advertise the R-values of their products at 75° F., the horizontal lines in FIG. 2 reflect this representation.

The following three roof insulation scenarios were modeled: (1) Using the Conduction Transfer Function (“CTF”) default algorithm for heat transfer across all building envelope surfaces including single thermal conductivity roof insulation associated with an R-value of 30 over a total thickness of 5.2 inches; (2) Same as scenario (1) with the exception that the CFD algorithm and variable thermal conductivity input was used, but with the same single thermal conductivity roof insulation associated with an R-value of 30 over a total thickness of 5.2 inches for all exposure temperatures; and (3) Using CTF default algorithm for heat transfer across all building envelope surfaces with the exception of using the CFD algorithm and variable thermal conductivity input reflective of the “measured TDRV Profile” of FIG. 2.

FIG. 4 illustrates the material input object for the polyisocyanurate insulation properties at 20° C. (68° F.) representing all 3 scenarios. FIG. 5 illustrates the input object for the roof configuration description. FIG. 6 illustrates the input object for Material Property/Variable Thermal Conductivity properties for the CFD solution algorithm for Scenarios (2) and (3). Note that Scenario (2) pulled the same thermal conductivity value for every temperature. Scenario (3) pulled a thermal conductivity value linearly extrapolated from the TDRV Profiles of FIG. 2 between each temperature/thermal conductivity input pair.

In order to derive meaningful conclusions from the output data, a net present value life cycle cost representation of results was selected for this this building envelope-based energy performance simulation. In this example—R30—two layers of 2.6 inch thick polyisocyanurate roof insulation—installed first costs for the model's 22,500 ft² roof from the RS Means construction cost database were as follows:
Actual first costs—$63,583 ($2.83/ft²)
Net present value first costs—$43,217 ($1.92/ft²)

In this simulation, the building was heated with natural gas with cooling and fans powered by electricity. The scenarios differed only by heat balance algorithm and/or k-factor variation by temperature for the roof insulation only. All other heat balance influencers were kept consistent across the three scenarios. Table 1 shows the whole building annual energy consumption for the selected building type and building location. As is apparent, Scenarios (2) and (3) showed higher annual heating and fans energy consumption but lower cooling energy consumption than scenario (1). Additionally, each of the conditioning equipment exhibit higher modeled energy consumption with Scenario (3) than Scenario (2).

TABLE 1

| MM Btu | Scenario (1) | Scenario (2) | Scenario (3) |
|---|---|---|---|
| Heating | 737.0 | 760.7 | 768.5 |
| Cooling | 60.5 | 56.0 | 57.5 |
| Fans | 138.5 | 143.9 | 148.2 |
| Total | 936.0 | 960.6 | 974.1 |

Based on the simulated energy consumption results, the resulting whole building net present value life cycle cost for conditioning energy for the selected building type and building location were determined, in which energy costs were based on U.S. national averages and the present value calculations included projected fuel cost escalators over the building life cycle. Results are shown in Table 2.

TABLE 2

| | Scenario (1) | Scenario (2) | Scenario (3) |
|---|---|---|---|
| Heating | $192,627 | $198,835 | $200,867 |
| Cooling | $27,586 | $25,521 | $26,186 |
| Fans | $63,139 | $65,602 | $67,546 |
| Total | $283,352 | $289,958 | $294,599 |

Table 3 illustrates the differences observed between the various scenarios for the specific selected roof insulation product, building type and building location. The absolute difference in energy consumption for Scenario (2) relative to Scenario (1), both with constant k-factor, was $0.477/ft² present value normalized to roof area. When replacing Scenario (2) with Scenario (3), an absolute difference of nearly $0.21/ft² resulted for Scenario (3) relative to Scenario (2). The relative magnitude of these differences can be appreciated by considering the total installed first costs present value of the polyisocyanurate insulation product was $1.92/ft².

TABLE 3

| $/ft² Roof Area | Scenario (1) | Scenario (2) | Scenario (3) |
|---|---|---|---|
| Heating | — | −$0.276 | −$0.366 |
| Cooling | — | $0.092 | $0.062 |
| Fans | — | −$0.109 | −$0.196 |
| Total | — | −$0.294 | −$0.500 |
| | | ABS $0.477 | ABS $0.624 |

### Example 2

In this Example, the Strip Mall model, illustrated by FIG. 3, and one of 17 prototype commercial buildings sponsored by the U.S. Department of Energy (“DOE”) and developed by the Pacific Northwest National Laboratory (“PNNL”), was used with populated EnergyPlus input files. The EnergyPlus input file reflects an ASHRAE 90.1-2016 compliant model. The selected location was Rochester, Minn. which is in ASHRAE Climate Zone 6A.

The various presumed constant and variable TDRV Profiles of FIG. 2 were analyzed: PIR (1) represented polyisocyanurate roof insulation with a total R-value of 30 that is presumed to remain constant at all exposure temperatures; PIR (2) represented a typical polyisocyanurate foam-forming formulation processed, aged and measured at various temperatures yielding TDRV Profiles at 3 thicknesses to provide R-values of R30 (“PIR (2)-R30”), R32.5 (“PIR (2)-R32.5”) and R35 (“PIR (2)-R35”) respectively; and PIR (3) represented the TDRV Profile of a specially formulated polyisocyanurate foam-forming composition designed to improve the temperature dependent R-value performance of the foam.

As with Example 1, comparisons were made based on present value life cycle cost methodology. The life cycle present value of the insulation and installation first cost—taken from the RS Means cost database—was calculated for each scenario. The present value of the annual energy consumption was modeled for the conditioning equipment—heating and cooling coils and fans—was calculated for each year of the life cycle period (40 years) for each scenario. As the roof insulation is the only variable in this example, all values were normalized to per square foot of roof. All scenarios utilized the CFD algorithm and the baseline scenario was the PIR (1) model. Table 4A illustrates the life cycle cost present value of the insulation and installation first costs.

TABLE 4A

| | Scenario | | | | |
|---|---|---|---|---|---|
| | PIR | PIR | PIR | PIR | PIR |
| $/ft² Roof Area | (1) | (2)-R30 | (2)-R32.5 | (2)-R35 | (3) |
| First Costs | $1.921 | $1.921 | $2.054 | $2.188 | $1.921 |

Savings/(Additional Cost)

| | | | | |
|---|---|---|---|---|
| Cost Diff. | $0 | ($0.133) | ($0.267) | $0 |

As is apparent, the PIR (2)-R32.5 and PIR (2)-R35 scenarios simulated adding and installing additional insulation, thus increasing first cost present value by 13 and 27 cents per square foot of roof area, respectively. For this example, the PIR (3) was presumed to be produced and sold at the same cost and price as the PIR (2) product.

Table 4B illustrates the life cycle cost present value of the whole building conditioning energy consumption for each scenario. For a PIR (2) formulation, and for the selected building type in the selected location, one can conclude that greater than an additional R-value of 2.5 is needed to equal the roofs low temperature performance relative to the PIR (1) representation (R-30 system presumed to perform equally at all heating exposure temperature exposures). PIR (3), on the other hand, lowered the temperature of onset of condensation of the blowing agent far enough to exhibit thermal performance better than the baseline for heating conditions. Even though designed to lower condensation temperatures, it is worthy to note that the PIR (3) formulation TDRV Profile in FIG. 2 indicated a softening of the warm-side line slope resulting in performance improvement in cooling energy consumption over PIR (2).

TABLE 4B

| | Scenario | | | | |
|---|---|---|---|---|---|
| | PIR | PIR | PIR | PIR | PIR |
| $/ft² Roof Area | (1) | (2)-R30 | (2)-R32.5 | (2)-R35 | (3) |
| Heating | $8.837 | $8.927 | $8.851 | $8.793 | $8.824 |
| Cooling | $1.134 | $1.164 | $1.149 | $1.136 | $1.144 |
| Fans | $2.916 | $3.002 | $2.984 | $2.965 | $2.935 |
| Total | $12.887 | $13.093 | $12.985 | $12.894 | $12.903 |

Savings/(Additional Cost)

| | | | | |
|---|---|---|---|---|
| Heating | ($0.090) | ($0.014) | $0.045 | $0.013 |
| Cooling | ($0.030) | ($0.015) | ($0.002) | ($0.009) |
| Fans | ($0.086) | ($0.069) | ($0.050) | ($0.020) |
| Total Diff. | ($0.206) | ($0.098) | ($0.007) | ($0.016) |

The methods of this specification facilitate establishing a holistic economic perspective for accessing roof insulation performance and comparison of available technologies for a specific building design, as illustrated by Table 4C. Although netting the greatest heating energy efficiency of the five scenarios, scenario PIR (2)-R35, which represented two layers of 3 inch thick polyisocyanurate foam produced from a typical polyisocyanurate foam-forming formulation, was the least cost effective of the evaluated scenarios. Furthermore, PIR (3), which involved 2 layers of 2.6 inch thick polyisocyanurate foam produced from a specially formulated polyisocyanurate foam-forming composition designed to improve the temperature dependent R-value performance of the foam, netted heating energy savings over the baseline at nearly equal its overall costs. It should be kept in mind, however, that PIR (1), which assumes a constant R-value performance of the foam, regardless of exposure temperature, is scientifically flawed.

TABLE 4C

| | Scenario | | | | |
|---|---|---|---|---|---|
| | PIR | PIR | PIR | PIR | PIR |
| $/ft² Roof Area | (1) | (2)-R30 | (2)-R32.5 | (2)-R35 | (3) |
| Total LCC PV | $14.81 | $15.01 | $15.04 | $15.08 | $14.82 |

Savings/(Additional Cost)

| | | | | |
|---|---|---|---|---|
| LCC PV Diff. | ($0.206) | ($0.231) | ($0.273) | ($0.016) |

The “right” sizing of HVAC equipment is paramount to the cost, energy efficiency and occupant comfort of any building design. To insure year round occupant comfort, sizing design calculations utilize extreme conditions for the given building and its location—extreme cold outdoor temperature for heating equipment design and extreme hot outdoor temperature (and humidity) for cooling equipment. In light of this, conventional acceptance of an insulation R-value at 75° F. to represent all surface temperature exposures along with use of the CTF algorithm is particularly problematic. By performing a building energy simulation using a CFD algorithm using temperature dependent thermal conductivity data for an identified thermal insulation product at a plurality of mean temperatures within the temperature range of −50 to 200° F., a building designer is provided benefits towards right sizing for occupant comfort and cost effectiveness, accurately identifying associated equipment costs, as well as reducing the amount of equipment manufacturer client complaint/call-backs. It should be readily apparent that life cycle cost present value simulations for HVAC equipment could be conducted in a manner analogous to that described above with respect to energy consumption and insulation costs. In other words, in addition to insulation first costs and energy consumption cost savings/penalties, equipment cost savings/penalties can be included in the analyses.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant(s) reserve the right to amend the claims during prosecution to add features as variously described in this specification, and such amendments comply with the requirements of 35 U.S.C. § 112, first paragraph, and 35 U.S.C. § 132(a).

What is claimed is:

1. A method for designing a building, comprising:
(a) performing a building energy simulation using a conduction finite difference algorithm using temperature dependent thermal conductivity data for thermal insulation at a plurality of mean temperatures within the temperature range of −50 to 200° F.; and
(b) selecting a thermal insulation product for use on the building that provides a desired estimated annual energy consumption for the building at least partly based on the result of the building energy simulation.

2. The method of claim 1, wherein the thermal insulation product comprises foam insulation.

3. The method of claim 2, wherein the foam insulation comprises a polyisocyanurate-modified polyurethane foam.

4. The method of claim 3, wherein the polyisocyanurate-modified polyurethane foam is the product of a polyisocyanurate foam-forming composition comprising a blowing agent composition comprising one or more hydrocarbon blowing agents with an atmospheric pressure boiling point of at least 68° F. (20° C.).

5. The method of claim 4, wherein the hydrocarbon blowing agent with an atmospheric pressure boiling point of at least 68° F. (20° C.) comprises n-pentane, isopentane, cyclopentane, or a mixture of any two or more thereof.

6. The method of claim 1, wherein the temperature dependent thermal conductivity data is generated by measuring the thermal resistance of the thermal insulation at a plurality of temperatures to identify a calculated inflection point temperature below which defines a first mathematical correlation between temperature and the thermal resistance of the insulation material and above which defines a second mathematical correlation between temperature and the thermal resistance of the insulation material.

7. The method of claim 6, wherein the plurality of temperatures comprises at least 3 temperatures less than 75° F. (23.9° C.), and (ii) at least 3 temperatures at and above 75° F. (23.9° C.).

8. The method of claim 6, wherein the step of performing a building energy simulation using a conduction finite difference algorithm using temperature dependent thermal conductivity data for thermal insulation at a plurality of mean temperatures within the temperature range of −50 to 200° F. comprises conducting the simulation using a plurality of different thermal insulations having different mathematical correlations and different calculated inflection point temperatures.

9. The method of claim 8, wherein the plurality of different insulation materials comprises a plurality of polyisocyanurate-modified polyurethane foams.

10. The method of claim 1, comprising selecting a net present value life cycle cost representation of results.

11. The method of claim 1, comprising simulating a building's annual conditioning energy consumption for each of a plurality of different insulation materials.

12. The method of claim 1, comprising designing the building with the insulation material that results in, based on the insulation materials evaluated, the lowest annual conditioning energy consumption, the lowest net present value life cycle cost, or the highest heat loss weighted R-value.

13. A method for constructing an insulated building, comprising installing a thermal insulation product on the building, wherein the thermal insulation product is at least partly selected based on the method of claim 1.

14. A method for sizing HVAC equipment for use in a building, comprising:
(a) identifying a thermal insulation product for use on the building;
(b) performing a building energy simulation using a conduction finite difference algorithm using temperature dependent thermal conductivity data for the thermal insulation at a plurality of mean temperatures within the temperature range of −50 to 200° F.; and
(c) sizing at least some of the HVAC equipment at least partly based on the result of the building energy simulation.

15. The method of claim 14, wherein the thermal insulation product comprises foam insulation.

16. The method of claim 15, wherein the foam insulation comprises a polyisocyanurate-modified polyurethane foam.

17. The method of claim 16, wherein the polyisocyanurate-modified polyurethane foam is the product of a polyisocyanurate foam-forming composition comprising a blowing agent composition comprising one or more hydrocarbon blowing agents with an atmospheric pressure boiling point of at least 68° F. (20° C.).

18. The method of claim 14, wherein the temperature dependent thermal conductivity data is generated by measuring the thermal resistance of the thermal insulation at a plurality of temperatures to identify a calculated inflection point temperature below which defines a first mathematical correlation between temperature and the thermal resistance of the insulation material and above which defines a second mathematical correlation between temperature and the thermal resistance of the insulation material.

19. The method of claim 18, wherein the plurality of temperatures comprises at least 3 temperatures less than 75° F. (23.9° C.), and (ii) at least 3 temperatures at and above 75° F. (23.9° C.).

20. A method comprising installing HVAC equipment in a building, wherein at least some of the HVAC equipment is sized by the method of claim 14.
